(19) United States
(12) Patent Application Publication
(10) Pub. No.: US 2003/0031605 A1
(43) Pub. Date: Feb. 13, 2003

(54) Air purifying passage and device

(75) Inventor: Yang-Chan Lin, Yung-Kang City (TW)

Correspondence Address: BACON & THOMAS, PLLC, 625 SLATERS LANE, FOURTH FLOOR, ALEXANDRIA, VA, 22314

(73) Assignee: Yang-Chan LIN, Tainan (TW)

(21) Appl. No.: 09/924,483

(22) Filed: Aug. 9, 2001

(51) Int. Cl. A62B 7/10; B06B 1/00

(52) U.S. Cl. 422/122; 422/171; 422/120; 422/128

(57) ABSTRACT

The present invention relates to the passage and device of an air purifier having a plurality of filter layers of light catalyst disposed layer by layer on a predetermined space, and a plurality of engraved openings formed on the surface of each filter layer, and a plurality of recessions formed on the surface panel. When each filter layer is stacked, the recession of each filter layer is disposed on surface of each filter layer below, and forms an isolating section at where the recession lands such that a plurality of passages having appropriate gaps between every two filter layers and every two isolating sections. The air can pass through the passage between two filter layers and thus accomplishes the disinfections effect, and such device can be installed between a base having a fan and a cover having a gas inlet and a gas outlet where an infrared light illuminates each filter layer.

### BACKGROUND OF THE INVENTION

1. Field of the Invention

The present invention relates to an air purifying passage and device having a simple structure of a quick and definite coating of light catalyst and an excellent air purification effect.

2. Description of the Prior Art

In general, the traditional air purifying device uses corrugated paper material or activated carbon for the filter to isolate the ash or dust for air purification. Titanium dioxide is used as the main constituent of the light catalyst, and a tiny incidence of infrared ray is used to initialize the catalysis, so that it can be widely used for disinfections and deodorization. Most of these devices are in a complicated honeycomb structure with a coating of light catalyst or a knitted net that allows the air to pass through them for disinfections. There was a design as shown in FIG. 1. A plurality of transparent inner tubes 11 are disposed axially in the transparent ventilation tube 1, and a plurality of small inner tubes 12 being disposed axially in each of the inner tubes 11. The ventilation tube 1, inner tube 11 and the smaller inner tube 12 are all coated with a coating of light catalyst, and a light source 13 is disposed inside the tubes to illuminate the light catalyst coating of the above-mentioned tubes and disinfect by light degeneration. The implementation as shown in FIG. 2 can also be used to form a plurality of parallel transparent isolating boards 21 in the ventilation tube 2 in order to separate the ventilation tube 2 into a plurality of slim partitions 22, and a plurality of longitudinal transparent isolating plates 23 can be used to further separate each of the partitions 22 into a slimmer partitions 24 and a light catalyst coating is coated on each of the partitions.

The design of such tube structure can indeed increase the airflow and is very practical, however due to the increase of air and the light catalyst contact surface on the tube wall give rise to better disinfections effect, therefore it is better to have more pairs of tubes. The more the tubes, the smaller are the diameters of the tubes. As the light catalyst is coated onto the tube wall by dipping or coating, the ends of the tube will have more dipping of light catalysts and less in the middle of the tube due to the viscosity of the light catalyst liquid. If the dipping time is elongated, then it is time consuming. If the light catalyst is diluted, its effect will be reduced.

In view of the shortcomings of the prior art mentioned above, the inventor of the present invention based on years of experience accumulated from the engagement in the related industry conducted extensive research to resolve the foregoing shortcomings and invented the heat sink structure of the present invention.

Therefore, the primary objective of the present invention is to provide an improved structure of the passage and device of an air purifier having a plurality of filter layers of light catalyst disposed layer by layer on a predetermined space, and a plurality of engraved openings formed on the surface of each filter layer, and a plurality of recessions formed on the surface panel. When each filter layer is stacked, the recession of each filter layer is disposed on surface of each filter layer below, and forms an isolating section at where the recession lands such that a plurality of passages having appropriate gaps between every two filter layers and every two isolating sections. The air can pass through the passage between two filter layers and thus accomplishes the disinfections effect, and such device can be installed between a base having a fan and a cover having a gas inlet and a gas outlet where an infrared light illuminates each filter layer.

To make it easier for our examiner to understand the objective of the invention, structure, innovative features, and performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 is a diagram showing the passage of a prior-art air purifier.

FIG. 2 is a diagram showing the passage of another prior-art air purifier.

FIG. 3 is a diagram showing the structure of a first preferred embodiment of the present invention.

FIG. 4 is a side-view diagram showing the stacking of the first preferred embodiment of the present invention.

FIG. 5 shows the application of the first preferred embodiment of the present invention.

FIG. 6 is a diagram showing the structure of a second preferred embodiment of the present invention.

FIG. 7 is a side-view diagram showing the stacking of the first preferred embodiment of the present invention.

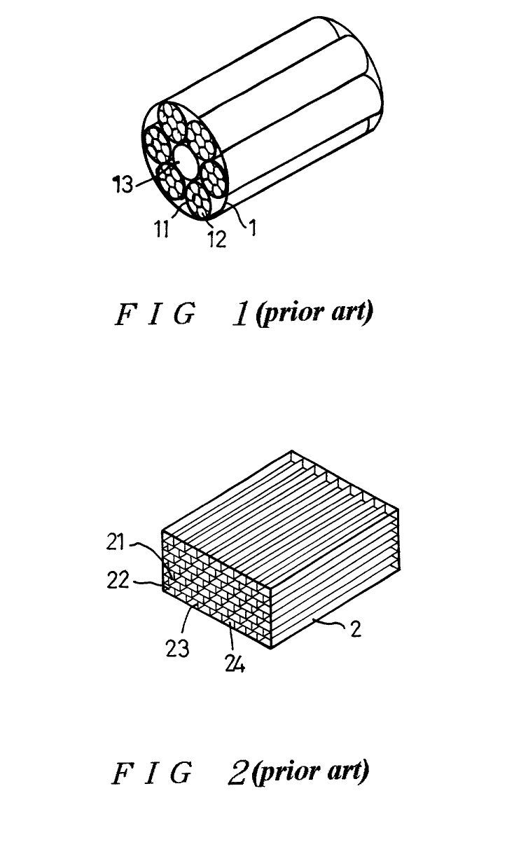

### DETAILED DESCRIPTION OF THE PREFERRED EMBODIMENT

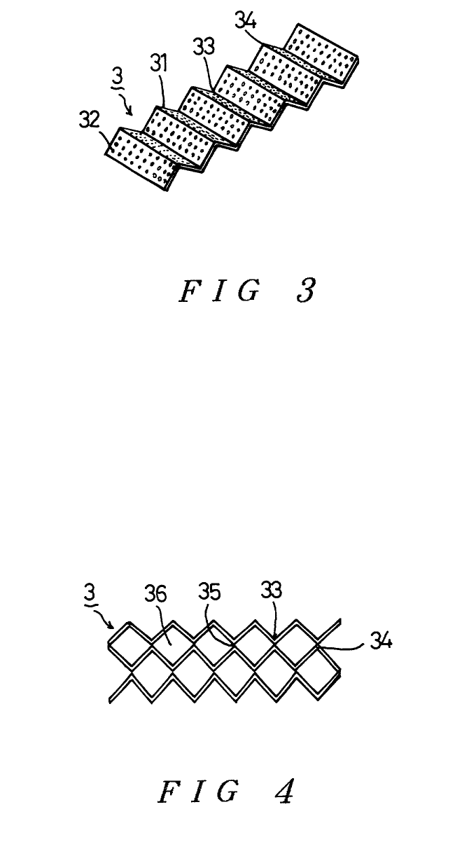

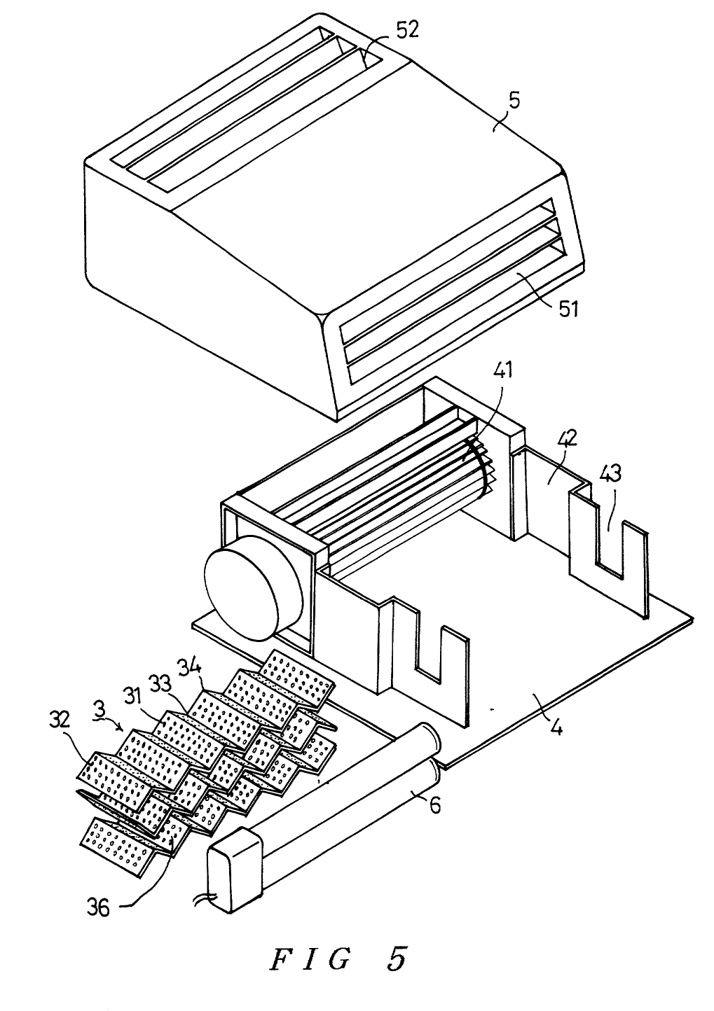

In the detailed description of the preferred embodiments, it should be noted that like elements are indicated by the same reference numerals throughout the disclosure. Referring to FIG. 3, the structure of a first embodiment of the present invention comprises a plurality of engraved openings on the surface 31 of the filter layer 3, and a plurality of recessions 33 being formed on the surface 31, and a corresponding protruding section 34 is disposed between two recessions 33 forming an entire form in the shape of a wave. As shown in FIG. 4, each of the filter layer 3 is stacked in a predetermined space such that the recession section 33 of each filter layer 3 fits in the protruding section 34 below the filter layer 3 to form an isolating section 35 and a plurality of passages with appropriated gaps between every two filter layers 3 and every two isolating sections 35.

In the coating or dipping of light catalyst, the light catalyst process is performed independently for each filter layer 3, and each filter layer 3 can be coated or dipped directly. Since the surface of the filter layer is a complete open space, it will not be blocked or will not have any difficulty on being coated or dipped, therefore the light catalyst can be quickly and evenly coated or dipped on it. It does not require dilution, and thus gives excellent disinfections effect. It can be applied in the way as the air purifying device as shown in FIG. 5, wherein a layer by layer of the filter layers 3 are stacked horizontal in a first fixing base 42 between a base 4 having a fan 41, a first fixed base 42, and a second fixed base 43 and a cover 5 having a gas inlet 51 and a gas outlet 52 such that an ultraviolet lamp 6 is disposed in the second fixed base 43 and the cover 5 is covered (the driving lines and switches of the air purifier of the present invention are prior art technologies and not the features of the present invention, therefore they are not described here.) After the air enters the gas inlet 51 and passes through the passages having light catalyst and each filter layer 3 is shined by the ultraviolet lamp for the disinfections, and the purified air is sent out via the gas outlet 52.

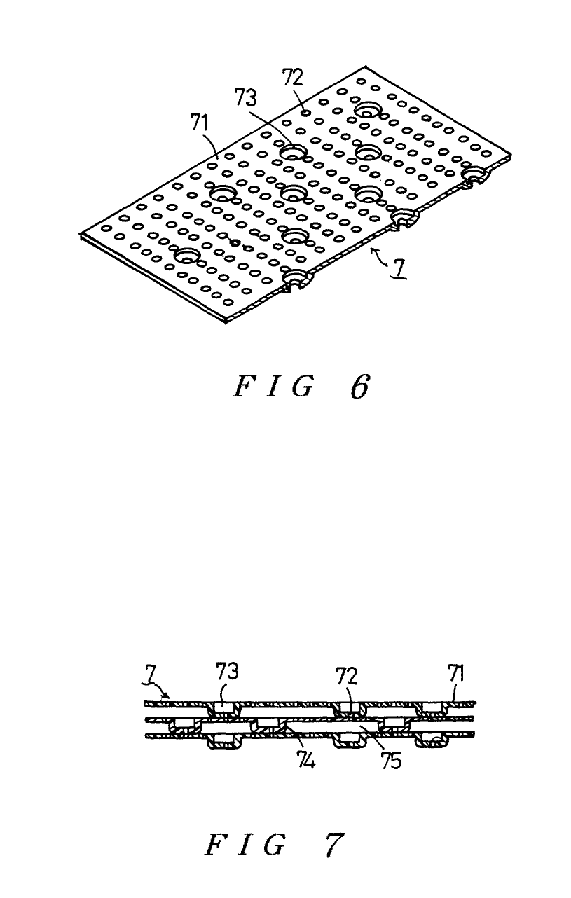

Referring to FIG. 6, the structure of a second embodiment of the present invention mainly uses the surface area 71 of a filter layer 7 to form a plurality of engraved openings 72, and a plurality of recession 73 on the surface 71. Each recession 73 is subsided from the engrave opening 72, and when each filter layer 7 is stacked layer by layer as shown in FIG. 7, the recession 73 of each filter layer 7 is disposed exactly below the surface 71 of the filter layer 7, and an isolating section 74 is formed corresponsive to the recessive area of each recession 73 such that a plurality of passages 75 with appropriate gaps between every two filter layers 7 and every tow isolating sections 74. As to the coating or dipping of light catalyst, each filter layer 7 can be coated or filtered by itself directly. Since the surface of the filter layer 7 is a complete open space, therefore it will not be blocked or will not have any difficult on coating or dipping, and also requires no dilution to give excellent disinfections effect.

The passage design of the air purifier according to the present invention is not just simple in structure, but also can be coated or dipped directly onto each filter layer during the coating or dipping of the light catalyst on the passage. It will not be blocked or have any difficult on the coating or dipping, therefore speed up the manufacture and give the same excellent disinfections effect. The aluminum material used for the plate as in the first embodiment is preferred, and the plastic plate used for the second embodiment is preferred.

Therefore, in summation of the above description, the present invention meets the requirements of patentability, which is hereby submitted for patent application. While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A passage of an air purifier, comprising a plurality of filter layers being stacked layer by layer in a predetermined space and further comprising a light catalyst; the surface of each filter layer having a plurality of engraved openings, and a plurality of recessions on the surface panel, as the filter layers are stacked, each of the concessions is disposed below the surface of the filter layer forming an isolating section at the position where the recession lands such that a plurality of passages having an appropriate gap between every two layer filters and every two isolating sections that allows the air to pass through the passage between two filter layers for disinfections.

2. A passage of an air purifier as claimed in claim 1, wherein said recessions of the filter layer are interlaced forming a protruding section between every two recessions, such that the entire structure is in a wave shape.

3. A passage of an air purifier as claimed in claim 2, wherein said isolating section is formed by coupling the recession of every filter layer to the protruded section of the filter layer below.

4. A passage of an air purifier as claimed in claim 1, wherein said filter layer is made of aluminum plates.

5. A passage of an air purifier as claimed in claim 1, wherein said recession of each filter layer is subsided from the engraved openings.

6. A passage of an air purifier as claimed in claim 5, wherein said filter layer is made of plastic plates.

7. A passage of an air purifier, having a light catalyst passage with the incident ultraviolet lamp shining on it between the base having a fan and a cover having a gas inlet and a gas outlet, characterized in that said passage comprises: a plurality of light catalyst filter layers being stacked layer by layer in a predetermined space, and the surface of each filter layer has a plurality of engraved openings, and a plurality of recessions being formed on the surface panel, as the filter layers are stacked, each of the concessions is disposed below the surface of the filter layer forming an isolating section at the position where the recession lands such that a plurality of passages having an appropriate gap between every two layer filters and every two isolating sections that allows the air to pass through the passage between two filter layers for disinfections.

8. A passage of an air purifier as claimed in claim 7 wherein said recession of each filter layer being interlaced with each other forms a protruded section between two recessions so that the entire structure is in a wave shape,

9. A passage of an air purifier as claimed in claim 8 wherein said isolating section is formed by coupling the recession of each filter layer to the protruded section of the filter layer below.

10. A passage of an air purifier as claimed in claim 7 wherein said filter layer is made of aluminum plates.

11. A passage of an air purifier as claimed in claim 7 wherein said recession of each filter layer being subsided from the engraved opening.

12. A passage of an air purifier as claimed in claim 1 wherein said filter layer is made of plastic plates.
